(19) United States
(12) Patent Application Publication
(10) Pub. No.: US 2026/0338999 A1
(43) Pub. Date: Oct. 29, 2026

(54) LENS MODULE AND COMPONENT FOR IMPROVING AN IMAGING QUALITY

(71) Applicant: Newmax Technology Co., Ltd., Taichung City (TW)

(72) Inventors: Yung-Fu LIANG, Taichung City (TW); Chiung-Hung CHEN, Taichung City (TW); Wei-Lan SHIH, Taichung City (TW)

(21) Appl. No.: 19/268,283

(22) Filed: Jul. 14, 2025

(30) Foreign Application Priority Data
Apr. 24, 2025 (TW) 114115612

(51) Int. Cl. G02B 5/00; G02B 7/02

(52) U.S. Cl. CPC G02B 5/003; G02B 7/021

(57) ABSTRACT

A component of a lens module for improving an image quality is selected from the group consisting of a lens barrel, an optical lens, a pressure ring and a spacer ring. The component includes: a component surface, a flat region and a microstructure region. The flat region is located on the component surface. The microstructure region is located on the component surface and adjacent to the flat region. Relative to the flat region, the microstructure region includes a plurality of protruding portions. Each protrusion portion includes a longitudinal section of a column that is narrow at the top and wide at the bottom. In the color space coordinate diagram, the microstructure region has chromaticity coordinates of L*, a* and b*, wherein 0.5<L*≤8. The microstructure region has a reflectivity of R, wherein 0.1%≤R≤1% @ [380, 1000 (nm)].

### CROSS-REFERENCE TO RELATED APPLICATION

This application claims the benefit of Taiwan Patent Application No. 114115612, filed on Apr. 24, 2025, which is hereby incorporated by reference for all purposes as if fully set forth herein.

### BACKGROUND

### Technical Field

The present disclosure relates to a lens module for improving an image quality, and in particular, to a component of a lens module for improving an image quality, wherein a microstructure region that can cause multiple reflections of light is formed on a component surface of the component, and the microstructure region has optical technical characteristics of lower reflectivity and lower chromaticity coordinates.

### Related Art

Stray light is a general term for unwanted light in the lens module, and are generated from residual reflection (such as light leakage and light transmission of the lens surface) on the surface of an optical component and residual reflection on the surface of a non-optical component (such as an inner wall of the lens barrel, and the like). The stray light may cause the performance of the lens module to degrade, reduce the modulation transfer function of the lens module, and damage the imaging quality of the lens module. The specific performance is the reduction in imaging clarity, and the reduction in color saturation.

Referring to FIG. 1, a conventional lens module 9 is mainly composed of components such as a lens barrel 91, optical lenses 92, a spacer ring 94, or a pressure ring 93. The anti-reflection effect of the lens barrel 91, the optical lenses 92, or the spacer ring 94 is to perform a coating process on a component surface requiring anti-reflection to form surface blackening, so as to effectively reduce the light reflectivity. However, the coating technology can significantly reduce the light reflectivity of the material itself, the coating process cannot effectively suppress the stray light because the coating process itself easily causes problems of poor appearance such as scratches, adhesion, film cracks, and the like, resulting in the problem of reduced yield.

The patent document (TW publication number: I823385B) has disclosed component for a lens module including: a component surface; a flat region located on the component surface; and a microstructure region located on the component surface and adjacent to the flat region; wherein relative to the flat region, the microstructure region includes a plurality of protruding portions and a plurality of concave portions. However, the patent document fails to disclose that the microstructure region has a lower reflectivity and lower chromaticity coordinates.

Therefore, it is necessary to provide a lens module and a component for improving an image quality, so as to resolve the foregoing problems.

### SUMMARY

An objective of the present disclosure is to provide a lens module and a component for improving an image quality, wherein a microstructure region that can cause multiple reflections of light is formed on a component surface of the component, and the microstructure region has optical technical characteristics of lower reflectivity and lower chromaticity coordinates (L*, a* and b*).

To achieve the above objective, the present disclosure provides a component of a lens module for improving an image quality, the component selected from a group consisting of a lens barrel, an optical lens, a pressure ring, and a spacer ring, and the component comprising: a component surface; a flat region located on the component surface; and a microstructure region located on the component surface and adjacent to the flat region; wherein: relative to the flat region, the microstructure region includes a plurality of protruding portions; each protrusion portion includes a longitudinal section of a column that is narrow at a top and wide at a bottom; in the color space coordinate diagram, the microstructure region has chromaticity coordinates of L*, a* and b*, wherein 0.5<L*≤8; and the microstructure region has a reflectivity of R, wherein 0.1%≤R≤1% @ [380, 1000 (nm)].

The present disclosure further provides a lens module, comprising: a lens barrel; an optical lens assembly disposed in the lens barrel and comprising a plurality of optical lenses; a pressure ring disposed in the lens barrel and abutting against the optical lens assembly; and a spacer ring disposed in the lens barrel and located in the optical lens assembly; wherein the above-mentioned component of the lens module for improving an image quality is selected from the group consisting of the lens barrel, the optical lens, the pressure ring, and the spacer ring.

The surface of the component of the lens module of the present disclosure is processed by a molding process (e.g., an injection molding process), whereby the microstructure region generating multiple reflections of light is formed on the component surface, and the microstructure region has optical technical characteristics of lower reflectivity and lower chromaticity coordinates (L*, a*, and b*), so as to change the scattering distribution characteristics of the component surface to achieve the effect of suppressing stray light.

### BRIEF DESCRIPTION OF THE DRAWINGS

FIG. 1 is a schematic cross-sectional view of a conventional lens module.

FIG. 2a to FIG. 2c are schematic sectional view (I) to view (III) of a lens module according to a first embodiment of the present disclosure.

FIG. 3 is a schematic sectional view of a flat region and a microstructure region on a component surface of a component of a lens module according to an embodiment of the present disclosure.

FIG. 4a to FIG. 4c are schematic longitudinal-sectional view (I) to view (III) of protruding portions of a microstructure region on a component surface of a component of a lens module according to an embodiment of the present disclosure.

FIG. 5 is a schematic three-dimensional view of a microstructure region on a component surface of a component of a lens module according to an embodiment of the present disclosure, showing protruding portions being in a shape of a cone.

FIG. 6a to FIG. 6c are schematic transverse-sectional view (I) to view (III) of protruding portions of a microstructure region on a component surface of a component of a lens module according to an embodiment of the present disclosure.

FIG. 7a to FIG. 7c are schematic plan view (I) to view (III) of protruding portions of a microstructure region on a component surface of a component of a lens module according to an embodiment of the present disclosure.

FIG. 8a to FIG. 8c are schematic longitudinal-sectional view (I) to view (III) of protruding portions of a microstructure region on a component surface of a component of a lens module according to another embodiment of the present disclosure.

FIG. 9 is a schematic three-dimensional view of a microstructure region on an inner surface of a mold according to an embodiment of the present disclosure.

FIG. 10 is a schematic plan view of a microstructure region on an inner surface of a mold according to an embodiment of the present disclosure, showing any area of 0.1 mm*0.1 mm in the microstructure region having n concave portions.

FIG. 11a is a plan view of a plurality of protruding portions (high-density design) of a microstructure region on a component surface of a component of a lens module according to an embodiment of the present disclosure.

FIG. 11b is a plan view of a plurality of protruding portions (low-density design) of a microstructure region on a component surface of a component of a lens module according to another embodiment of the present disclosure.

FIG. 12a is a schematic view showing the relationship between the reflectivity (protruding portions has high-density design) and the wavelength of the general structure in the prior art and those of a special structure of the present disclosure.

FIG. 12b is a schematic view showing the relationship between the reflectivity (protruding portions has low-density design) and the wavelength of the general structure in the prior art and those of another special structure of the present disclosure.

FIG. 13 is a schematic sectional view of a lens module according to a second embodiment of the present disclosure.

FIG. 14 is a schematic sectional view of a lens module according to a third embodiment of the present disclosure.

FIG. 15 is a schematic sectional view of a lens module according to a fourth embodiment of the present disclosure.

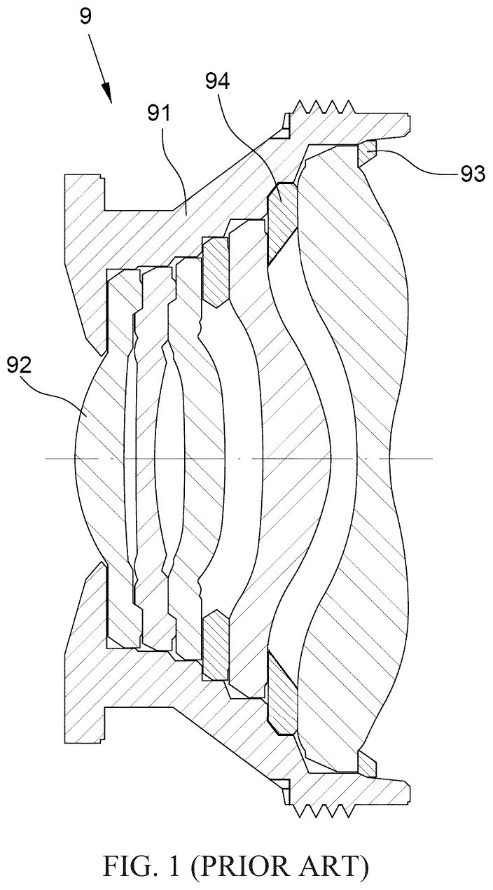

### DETAILED DESCRIPTION

To make the foregoing objective, features, and characteristics of the present disclosure clearer and more comprehensive, detailed descriptions are provided below with reference to the accompanying drawings.

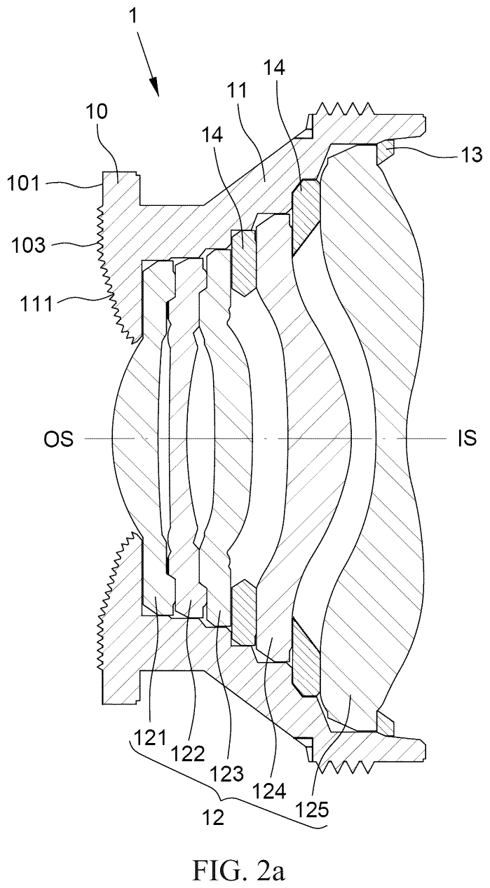

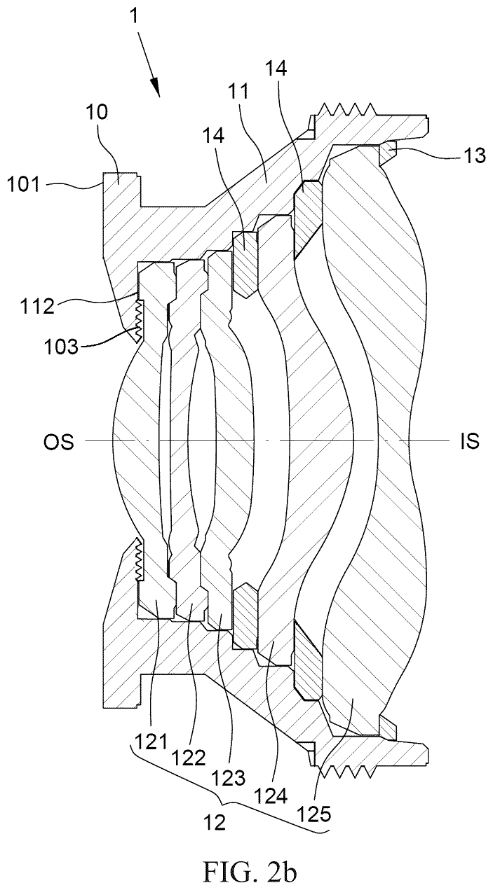

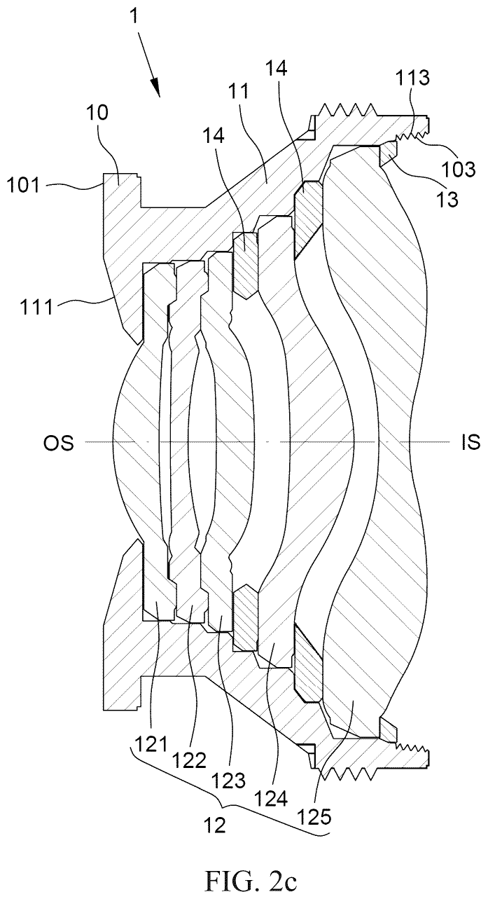

FIG. 2a to FIG. 2c are schematic sectional views (I)-(III) of a lens module according to the first embodiment of the present disclosure. Referring to FIG. 2a, a lens module 1 includes a lens barrel 11, an optical lens assembly 12, a pressure ring 13, and at least one spacer ring 14. The lens barrel 11 may be an integrated lens barrel and may be made of plastic material. The optical lens assembly 12 is disposed in an accommodating space of the lens barrel 11 and includes a plurality of optical lenses. The optical lenses may be made of plastic material or glass material. The pressure ring 1 is also disposed in the lens barrel 11 and abuts against the optical lens assembly 12 to prevent the optical lenses from falling out of the lens barrel 11. The pressure ring 13 may be made of metal material or plastic material. The spacer ring 14 is also disposed in the lens barrel 11 and located in the optical lens assembly 12 to determine a distance between two adjacent optical lenses, so as to control an air space between the two adjacent optical lenses. A material of the spacer ring 14 may be metal material or plastic material. For example, the lens module 1 includes, in order from an object-side OS to an image-side IS, a first optical lens 121, a second optical lens 122, a third optical lens 123, the spacer ring 14, a fourth optical lens 124, the spacer ring 14, a fifth optical lens 125, and the pressure ring 13. A component 10 for the lens module 1 of the present disclosure is at least one component 10 selected from a group consisting of the lens barrel 11, the first to fifth optical lenses 121-125, the pressure ring 13, and the spacer ring 14. In the first embodiment, the component 10 for the lens module 1 of the present disclosure is the lens barrel 11. A microstructure region 103 can be located on at least one of an object-side surface 111 (shown in FIG. 2a), an image-side surface 112 (shown in FIG. 2b), and an inner annular surface 113 (shown in FIG. 2c) of a component surface 101 (i.e., the lens barrel surface).

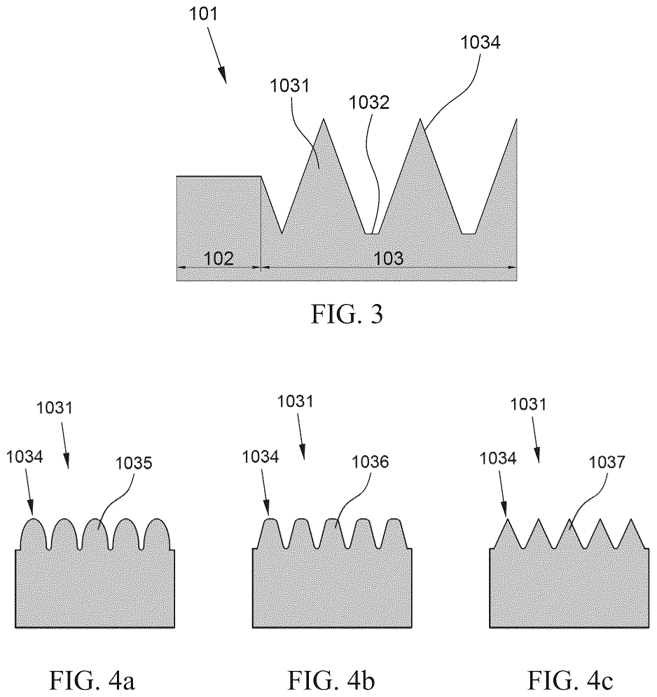

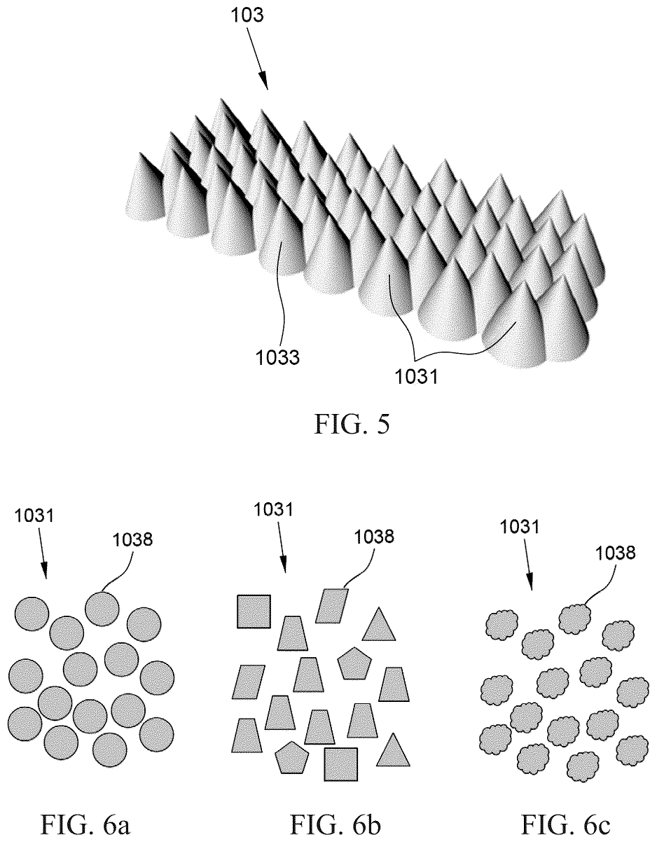

FIG. 3 is a schematic sectional view of a flat region and a microstructure region on a component surface of a component of a lens module according to an embodiment of the present disclosure. FIG. 4a to FIG. 4c are schematic longitudinal-sectional view (I) to view (III) of protruding portions of a microstructure region on a component surface of a component of a lens module according to an embodiment of the present disclosure. Referring to FIG. 2a and FIG. 3, the component 10 (i.e., the lens barrel 11) includes a component surface 101 (i.e., the lens barrel surface), a flat region 102, and a microstructure region 103. The flat region 102 is located on the component surface 101. The microstructure region 103 is located on the component surface 101 and adjacent to the flat region 102. Relative to the flat region 102, the microstructure region 103 includes a plurality of protruding portions 1031 and a plurality of concave portions 1032. any area of 0.1 mm*0.1 mm in the microstructure region 103 has n protruding portions 1031, wherein 10≤n≤90. Each protrusion portion 1031 includes a longitudinal section 1034 of a column that is narrow at the top and wide at the bottom, and the longitudinal section 1034 of the column that is narrow at the top and wide at the bottom is selected from the group consisting of an arc-shaped column section 1035 (shown in FIG. 4a), an upper arc-shaped and lower straight-shaped column section 1036 (shown in FIG. 4b), and a conical column section 1037 (shown in FIG. 4c). FIG. 5 is a schematic three-dimensional view of a microstructure region on a component surface of a component of a lens module according to an embodiment of the present disclosure, showing protruding portions 1031 being in a shape of a cone 1033. In another embodiment, the protruding portions 1031 may be in a pyramidal shape or a polygonal-pyramidal shape (not shown).

FIG. 6a to FIG. 6c are schematic transverse-sectional view (I) to view (III) of protruding portions of a microstructure region on a component surface of a component of a lens module according to an embodiment of the present disclosure. Referring to FIG. 6a to FIG. 6c, each protruding portion 1031 further includes: a transverse section 1038, and the transverse section 1038 can be selected from the group consisting of: a circle, an ellipse, a triangle, a polygon with more than three sides, and an arc with a concave and protruding contour line, so as to facilitate the manufacture of the protruding portions 1031.

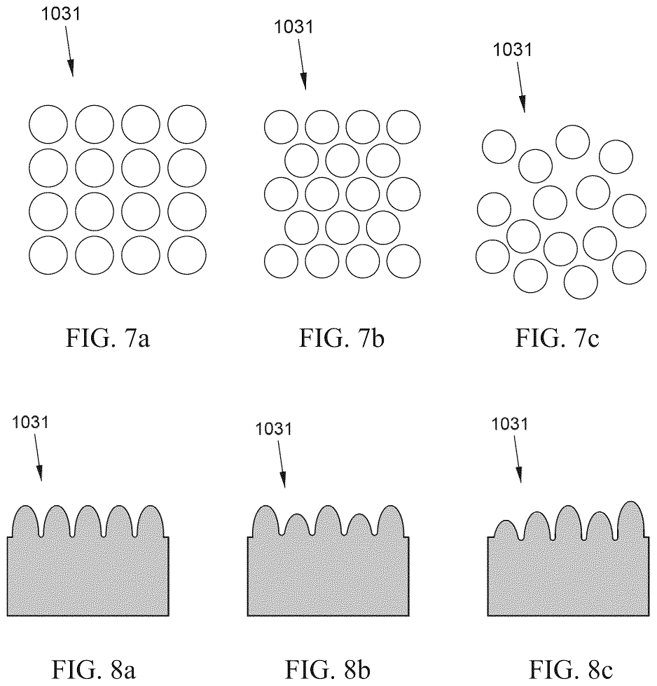

FIG. 7a to FIG. 7c are schematic plan view (I) to view (III) of protruding portions of a microstructure region on a component surface of a component of a lens module according to an embodiment of the present disclosure. Referring to FIG. 7a, the arrangement of the protruding portions 1031 on the microstructure region is: an array arrangement, so as to facilitate the manufacture of the protruding portions 1031. Referring to FIG. 7b, the arrangement of the protruding portions on the microstructure region is: the densest regular arrangement with the largest number of non-overlapping protruding portions 1031 placed within a certain area, so as to increase the density of the protruding portions 1031. Referring to FIG. 7c, the arrangement of the protruding portions 1031 on the microstructure region may be: an irregular arrangement, so as to facilitate the design of the arrangement of the protruding portions 1031.

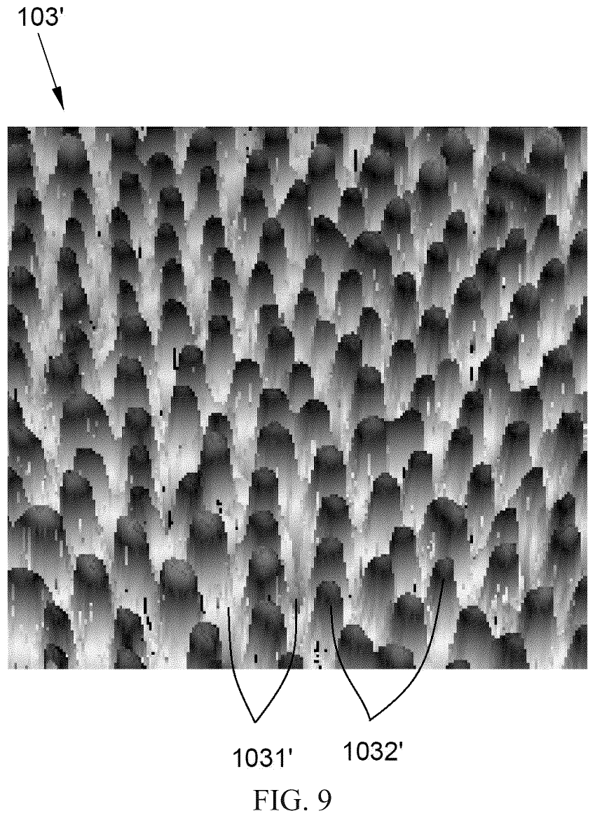

FIG. 8a to FIG. 8c are schematic longitudinal-sectional view (I) to view (III) of protruding portions of a microstructure region on a component surface of a component of a lens module according to another embodiment of the present disclosure. Referring to FIG. 8a, the protruding portions 1031 have the same height, so as to facilitate the manufacture of the protruding portions 1031. Referring to FIG. 8b, the protruding portions 1031 are divided into at least two types, and the protruding portions 1031 of each type have the same height and are staggered, so as to facilitate the manufacture of the protruding portions 1031. Referring to FIG. 8c, the heights of the protruding portions 1031 can be randomly unequal, so as to facilitate the design of the protruding portions 1031.

Thus, according to the component (i.e., lens barrel) used for the lens module of the present disclosure, in the color space coordinate diagram, the microstructure region has chromaticity coordinates of L*, a*, and b*, wherein 0.5<L*≤8, 0.0≤|a*|<0.5 and 0.0<|b*|<1.0. The microstructure region has a reflectivity of R, wherein 0.1%≤R≤1% @ [380, 1000 (nm)]. The surface of the component (i.e., lens barrel) of the lens module of the present disclosure is processed by a molding process (e.g., an injection molding process), whereby the microstructure region generating multiple reflections of light is formed on the component surface, and the microstructure region has optical technical characteristics of lower reflectivity and lower chromaticity coordinates (L*, a*, and b*), so as to change the scattering distribution characteristics of the component surface to achieve the effect of suppressing stray light. For example, CIELAB is the mainstream color space coordinate system used to represent visual colors today. It is developed by the International Commission on Illumination (CIE) and uses three coordinate values, L*, a*, and b*, to represent the colors seen by the eyes. It expresses colors with three values: L* represents the perceived brightness, and a* and b* represent the four unique colors of human vision: red, green, blue, and yellow.

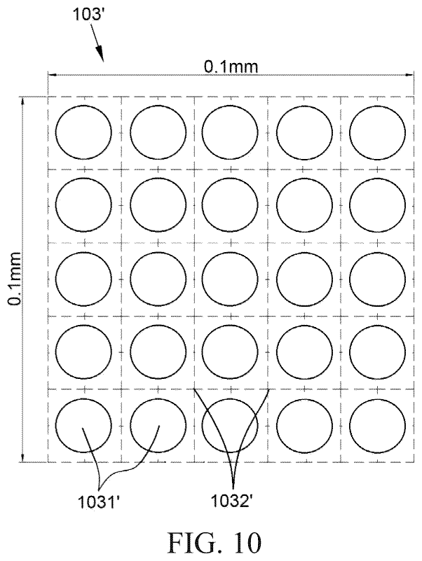

FIG. 9 is a schematic three-dimensional view of a microstructure region on an inner surface of a mold according to an embodiment of the present disclosure. Referring to FIG. 9 and FIG. 3, the inner surface of the mold refers to an inner surface of an injection mold for manufacturing the lens barrel 11. For example, a plurality of concave portions 1031′ (e.g., conical holes) are formed in the inner surface of the mold by using a laser drilling process, and a plurality of protruding portions 1032′ are formed at locations of molten metal deposition among the concave portions 1031′. The concave portions 1031′ and the protruding portions 1032′ of the microstructure region 103′ on the inner surface of the mold correspond to the protruding portions 1031 and the concave portions 1032 of the microstructure region 103 on the component surface 101. In this way, during the injection molding process, the concave portions 1031′ and the protruding portions 1032′ of the microstructure region 103′ on the inner surface of the mold can be transferred into the protruding portions 1031 and the concave portions 1032 of the microstructure region 103 on the component surface 101 in a transfer printing manner. FIG. 10 is a schematic plan view of a microstructure region on an inner surface of a mold according to an embodiment of the present disclosure. Any area of 0.1 mm*0.1 mm in the microstructure region 103′ on the inner surface of the mold has n concave portions 1031′, wherein 10≤n≤90. In other words, referring to FIG. 3 and FIG. 5 again, any area of 0.1 mm*0.1 mm in the microstructure region 103 on the component surface 101 has n protruding portions 1031, wherein 10≤n≤90, so that the microstructure region 103 can reduce the light reflection effect and suppress stray light.

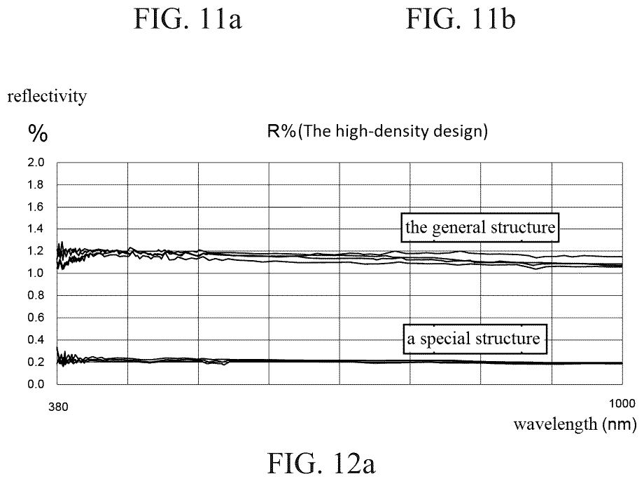

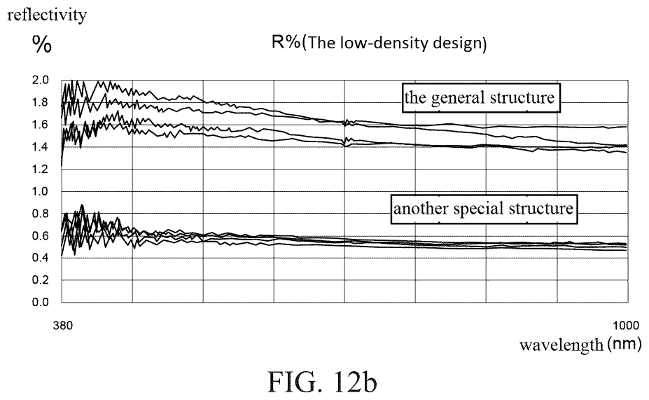

FIG. 11a is a plan view of a plurality of protruding portions (high-density design) of a microstructure region on a component surface of a component of a lens module according to an embodiment of the present disclosure. According to the high-density design of the protruding portions 1031, there are n protruding portions 1031 located in the area of 0.1 mm*0.1 mm in the microstructure region on the component surface of the component of the lens module, wherein 50<n≤90. For example, FIG. 12a is a schematic view showing the relationship between the reflectivity (the protruding portions have high-density design) and the wavelength of the general structure (which is formed by a discharge process and then transferred to the component surface) in the prior art and those of a special structure (which is formed by a laser process and then transferred to the microstructure region on the component surface) of the present disclosure. Table 1 is a comparison table of the chromaticity coordinates (the protruding portions have high-density design) of the general structure in the prior art and a special structure of the present disclosure. When there are 80 protruding portions 1031 located in the area of 0.1 mm*0.1 mm in the microstructure region on the component surface of the component of the lens module of the present disclosure, the microstructure region has a reflectivity R, where 0.1%≤R≤0.4% @ [380,1000 (nm)], and the microstructure region has chromaticity coordinate L*, where 0.5<L*≤4, whereby the microstructure region can further reduce the light reflection effect.

TABLE 1
The high-density design of the protruding portions

| | the general structure in the prior art | | | | | a special structure of the present disclosure | | | | |
|---|---|---|---|---|---|---|---|---|---|---|
| | No. 1 | No. 2 | No. 3 | No. 4 | No. 5 | No. 1 | No. 2 | No. 3 | No. 4 | No. 5 |
| L* | 10.2 | 9.9 | 10.3 | 10.2 | 10.2 | 1.7 | 1.8 | 2.0 | 1.8 | 1.9 |
| a* | −0.1 | 0.0 | 0.2 | −0.1 | −0.1 | 0.0 | 0.0 | 0.0 | 0.0 | 0.0 |
| b* | −0.5 | −0.5 | −0.2 | −0.4 | −0.5 | −0.2 | −0.2 | −0.2 | −0.2 | −0.1 |

FIG. 11b is a plan view of a plurality of protruding portions (low-density design) of a microstructure region on a component surface of a component of a lens module according to another embodiment of the present disclosure. According to the low-density design of the protruding portions 1031, there are n protruding portions 1031 located in the area of 0.1 mm*0.1 mm in the microstructure region on the component surface of the component of the lens module, wherein 10≤n≤50. For example, FIG. 12b is a schematic view showing the relationship between the reflectivity (the protruding portions have low-density design) and the wavelength of the general structure (which is formed by a discharge process and then transferred to the component surface) in the prior art and those of another special structure (which is formed by a laser process and then transferred to the microstructure region on the component surface) of the present disclosure. Table 2 is a comparison table of the chromaticity coordinates (the protruding portions have low-density design) of the general structure in the prior art and another special structure of the present disclosure. When there are 20 protruding portions 1031 located in the area of 0.1 mm*0.1 mm in the microstructure region on the component surface of the component of the lens module of the present disclosure, the microstructure region has a reflectivity R, where 0.1%≤R≤1% @ [380,1000 (nm)], and the microstructure region has chromaticity coordinate L*, where 4<L*≤8, whereby the microstructure region can reduce the light reflection effect and be easily formed.

TABLE 2
The low-density design of the protruding portions

| | the general structure in the prior art | | | | | another special structure of the present disclosure | | | | |
|---|---|---|---|---|---|---|---|---|---|---|
| | No. 1 | No. 2 | No. 3 | No. 4 | No. 5 | No. 1 | No. 2 | No. 3 | No. 4 | No. 5 |
| L* | 13.7 | 12.2 | 13.5 | 12.6 | 14.4 | 5.0 | 4.4 | 4.8 | 4.7 | 4.6 |
| a* | −0.5 | −0.2 | −0.3 | −0.4 | −0.6 | −0.2 | −0.2 | −0.1 | −0.1 | −0.3 |
| b* | −1.8 | −0.8 | −0.9 | −0.7 | −1.7 | −0.8 | −0.5 | −1.0 | −0.6 | −0.5 |

Referring to FIG. 2a to FIG. 2c, when the component 10 for the lens module 1 is the lens barrel 11, the microstructure region 103 may be located on an object-side surface 111 (shown in FIG. 2a), an image-side surface 112 (shown in FIG. 2b), or an inner ring surface 113 (shown in FIG. 2c) of the component surface 101 (i.e., a surface of the lens barrel 11). If the microstructure region 103 is applied to a surface (i.e., the object-side surface 111) of a light-transmitting hole of the lens barrel 11, the microstructure region 103 has the effect of reducing the reflectivity. If the microstructure region 103 is applied to a surface on the inner side of the lens barrel 11 (i.e., the image-side surface 112 and the inner ring surface 113), the microstructure region 103 has the effect of reducing the reflectivity and can suppress the stray light.

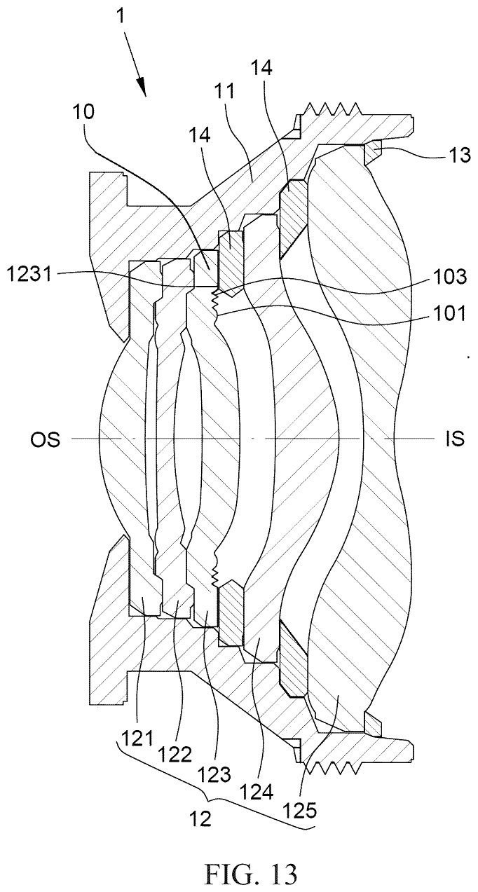

FIG. 13 is a schematic sectional view of a lens module according to a second embodiment of the present disclosure. The lens module of the second embodiment is substantially similar to the lens module of the first embodiment, and similar components are marked with similar reference numerals. A difference between the lens modules 1 of the second embodiment and the first embodiment is as follows. In the second embodiment, the component 10 for the lens module 1 of the present disclosure is an optical lens (e.g., the third optical lens 123), and the microstructure region 103 is located on a non-optical region 1231 of the component surface 101 (i.e., a surface of the optical lens 123), and is not in contact with other components 10 (e.g., the spacer ring 14) for the lens modules 1. The structure and functions of the microstructure region 103 of the second embodiment are the same as those of the microstructure region 103 of the first embodiment, and the details are not described. If the microstructure region 103 is applied to the optical lens, the microstructure region 103 may be disposed outside the optical region of the optical lens (i.e., the non-optical region 1231) without affecting the demolding position, so as to have the effect of reducing the reflectivity and suppress the stray light.

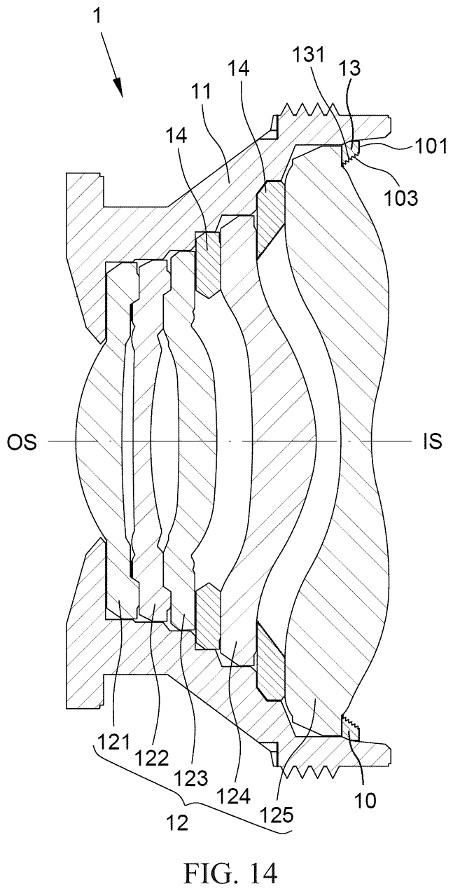

FIG. 14 is a schematic sectional view of a lens module according to a third embodiment of the present disclosure. The lens module of the third embodiment is substantially similar to the lens module of the first embodiment, and similar components are marked with similar reference numerals. A difference between the lens modules 1 of the third embodiment and the first embodiment is as follows. In the third embodiment, the component 10 for the lens module 1 of the present disclosure is the pressure ring 13, and the microstructure region 103 is located on an inner ring surface 131 of the component surface 101 (i.e., a surface of the pressure ring 13). The structure and functions of the microstructure region 103 of the third embodiment are the same as those of the microstructure region 103 of the first embodiment, and the details are not described. If the microstructure region 103 is applied to the pressure ring 13, the microstructure region 103 may be disposed on the inner ring surface 131 of the component surface 101 (i.e., the surface of the pressure ring 13), so as to have the effect of reducing reflectivity and suppress stray light.

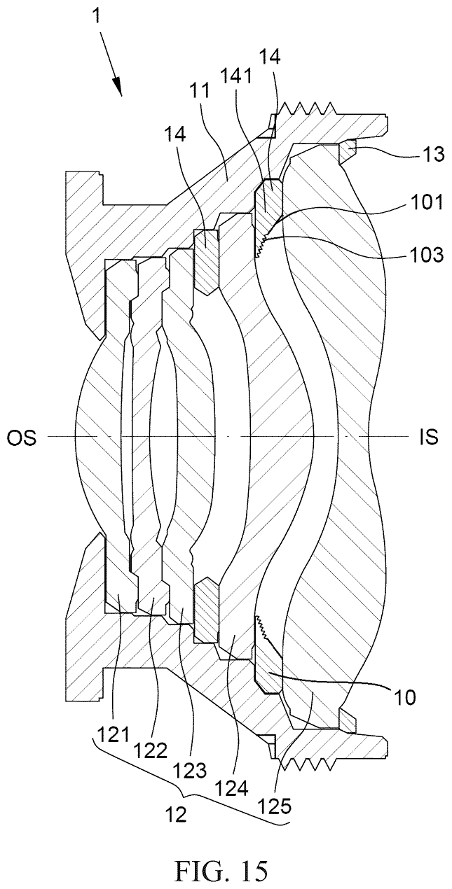

FIG. 15 is a schematic sectional view of a lens module according to a fourth embodiment of the present disclosure. The lens module of the fourth embodiment is substantially similar to the lens module of the first embodiment, and similar components are marked with similar reference numerals. A difference between the lens module 1 of the fourth embodiment and the first embodiment is as follows. In the fourth embodiment, the component 10 for the lens module 1 of the present disclosure is the spacer ring 14, and the microstructure region 103 is located on an inner ring surface 141 of the component surface 101 (i.e., a surface of the spacer ring 14). The structure and functions of the microstructure region 103 of the fourth embodiment are the same as those of the microstructure region 103 of the first embodiment, and the details are not described. If the microstructure region 103 is applied to the spacer ring 14, the microstructure region 103 may be disposed on the inner ring surface 141 of the component surface 101 (i.e., the surface of the spacer ring 14), so as to have the effect of reducing reflectivity and suppress stray light.

In conclusion, preferred implementations or embodiments of the technical means adopted by the present disclosure to resolve the problems of the present disclosure are merely recorded, and are not intended to limit the scope of implementation of the present disclosure. That is, any equivalent changes and modifications literally conforming to the scope of the claims of the present disclosure or made according to the scope of the claims of the present disclosure shall fall within the scope of the present disclosure.

What is claimed is:

1. A component of a lens module for improving an image quality, the component selected from a group consisting of a lens barrel, an optical lens, a pressure ring, and a spacer ring, and the component comprising:
a component surface;
a flat region located on the component surface; and
a microstructure region located on the component surface and adjacent to the flat region; wherein:
relative to the flat region, the microstructure region includes a plurality of protruding portions;
each protrusion portion includes a longitudinal section of a column that is narrow at a top and wide at a bottom;
in the color space coordinate diagram, the microstructure region has chromaticity coordinates of L*, a* and b*, wherein 0.5<L*≤8; and
the microstructure region has a reflectivity of R, wherein 0.1%≤R≤1% @ [380, 1000 (nm)].

2. The component of a lens module for improving an image quality according to claim 1, wherein any area of 0.1 mm*0.1 mm in the microstructure region has n protruding portions, wherein 10≤n≤90.

3. The component of a lens module for improving an image quality according to claim 2, wherein 10≤n≤50 and 0.5<L*≤4.

4. The component of a lens module for improving an image quality according to claim 2, wherein 50<n≤90 and 4<L*≤8.

5. The component of a lens module for improving an image quality according to claim 3, wherein 0.0≤|a*|<0.5 and 0.0<|b*|<1.0.

6. The component of a lens module for improving an image quality according to claim 4, wherein the longitudinal section of the column that is narrow at the top and wide at the bottom is selected from the group consisting of an arc-shaped column section, an upper arc-shaped and lower straight-shaped column section, and a conical column section.

7. The component of a lens module for improving an image quality according to claim 1, wherein each protruding portion further includes a transverse section, and the transverse section is selected from the group consisting of: a circle, an ellipse, a triangle, a polygon with more than three sides, and an arc with a concave and protruding contour line.

8. The component of a lens module for improving an image quality according to claim 1, wherein the arrangement of the protruding portions on the microstructure region is: an array arrangement, or a densest regular arrangement with the largest number of non-overlapping protruding portions placed within a certain area.

9. The component of a lens module for improving an image quality according to claim 1, wherein the protruding portions have the same height; or
the protruding portions are divided into at least two types, and the protruding portions of each type have the same height and are staggered.

10. A lens module, comprising:
a lens barrel;
an optical lens assembly disposed in the lens barrel and comprising a plurality of optical lenses;
a pressure ring disposed in the lens barrel and abutting against the optical lens assembly; and
a spacer ring disposed in the lens barrel and located in the optical lens assembly;
wherein a component of the lens module for improving an image quality is selected from the group consisting of the lens barrel, the optical lens, the pressure ring, and the spacer ring, and the component comprises:
a component surface;
a flat region located on the component surface; and
a microstructure region located on the component surface and adjacent to the flat region; wherein:
relative to the flat region, the microstructure region includes a plurality of protruding portions;
each protrusion portion includes a longitudinal section of a column that is narrow at a top and wide at a bottom;
in the color space coordinate diagram, the microstructure region has chromaticity coordinates of L*, a* and b*, wherein 0.5<L*≤8; and
the microstructure region has a reflectivity of R, wherein 0.1%≤R≤1% @ [380, 1000 (nm)].

11. The lens module for improving an image quality according to claim 1, wherein any area of 0.1 mm*0.1 mm in the microstructure region has n protruding portions, wherein 10≤n≤90.

12. The lens module for improving an image quality according to claim 11, wherein 10≤n≤50 and 0.5<L*≤4.

13. The lens module for improving an image quality according to claim 11, wherein 50<n≤90 and 4<L*≤8.

14. The lens module for improving an image quality according to claim 10, wherein 0.0≤|a*|<0.5 and 0.0<|b*|<1.0.

15. The lens module for improving an image quality according to claim 10, wherein the longitudinal section of the column that is narrow at the top and wide at the bottom is selected from the group consisting of an arc-shaped column section, an upper arc-shaped and lower straight-shaped column section, and a conical column section.

16. The lens module for improving an image quality according to claim 10, wherein each protruding portion further includes a transverse section, and the transverse section is selected from the group consisting of: a circle, an ellipse, a triangle, a polygon with more than three sides, and an arc with a concave and protruding contour line.

17. The lens module for improving an image quality according to claim 10, wherein the arrangement of the protruding portions on the microstructure region is: array arrangement, or a densest regular arrangement with the largest number of non-overlapping protruding portions placed within a certain area.

18. The lens module for improving an image quality according to claim 10, wherein the protruding portions have the same height; or
the protruding portions are divided into at least two types, and the protruding portions of each type have the same height and are staggered.
